(19) United States
(12) Patent Application Publication
(10) Pub. No.: US 2025/0332510 A1
(43) Pub. Date: Oct. 30, 2025

(54) Method and Apparatus for Processing Interaction Data of Virtual Scene, Device, Storage Medium, and Computer Program Product

(71) Applicant: Tencent Technology (Shenzhen) Company Limited, Shenzhen (CN)

(72) Inventor: Ying Deng, Shenzhen (CN)

(21) Appl. No.: 19/261,254

(22) Filed: Jul. 7, 2025

Related U.S. Application Data
(63) Continuation of application No. PCT/CN2024/097575, filed on Jun. 5, 2024.

(30) Foreign Application Priority Data
Jul. 13, 2023 (CN) 2023108611553

(51) Int. Cl. A63F 13/5378; A63F 13/52; A63F 13/5372; A63F 13/5375; A63F 13/55

(52) U.S. Cl. CPC A63F 13/5378; A63F 13/52; A63F 13/5372; A63F 13/5375; A63F 13/55

(57) ABSTRACT

Mapping and character movement techniques within a virtual scene of interactive media are described herein. The techniques may include displaying a virtual scene, the virtual scene including a virtual character; displaying an indicator of a virtual task in the virtual scene in response to a trigger operation of the virtual task, the indicator being configured for pointing from a current position of the virtual character to a target position of the virtual task; and displaying a small map in the virtual scene when a predetermined condition for the small map is satisfied. The target position may be displayed in the small map.

### CROSS-REFERENCE TO RELATED APPLICATIONS

This application is a Continuation Application of PCT Application PCT/CN2024/097575 filed Jun. 5, 2024, which claims priority to Chinese Patent Application No. 202310861155.3 filed Jul. 13, 2023, each entitled “Method and Apparatus for Processing Interaction Data of Virtual Scene, Device, Storage Medium, and Computer Program Product” each of which is incorporated by reference in its entirety.

### FIELD

Aspects described herein relate to the field of computer graphics and image technologies, and in particular, to a method and apparatus for processing interaction data of a virtual scene, an electronic device, a computer-readable storage medium, and a computer program product.

### BACKGROUND

A display technology based on graphics processing hardware expands channels for environment sensing and information obtaining. In particular, a virtual scene display technology can achieve diversified interactions between virtual objects controlled by a user or artificial intelligence based on an actual application requirement, and is applicable to various typical application scenarios. For example, the display technology can simulate a real interaction process between virtual objects in a virtual scene such as a game.

In the related art, a player needs to jump to a large map interface from a main interface of the game, and after selecting a virtual task on the large map interface, controls a virtual object to head to a target position of the virtual task according to guidance of a small map that is always fixedly displayed in a large map. This interaction manner occupies a large amount of display space, easily causing a problem of information redundancy, and consequently affecting user experience.

### SUMMARY

Aspects described herein provide a method and apparatus for processing interaction data of a virtual scene, an electronic device, a computer-readable storage medium, and a computer program product, which can save display space of a small map.

Technical solutions of the aspects described herein are implemented as follows.

An aspect described herein provides a method for processing interaction data of a virtual scene, including:
displaying a virtual scene, the virtual scene including a virtual object;
displaying an indicator of a virtual task in the virtual scene in response to a trigger operation of the virtual task, the indicator being configured for pointing from a current position of the virtual object to a target position of the virtual task; and
displaying a small map in the virtual scene in response to that a display condition for the small map is satisfied, the target position being displayed in the small map.

An aspect described herein provides an apparatus for processing interaction data of a virtual scene, including:
a first display module, configured to display a virtual scene, the virtual scene including a virtual object;
a task module, configured to display an indicator of a virtual task in the virtual scene in response to a trigger operation of the virtual task, the indicator being configured for pointing from a current position of the virtual object to a target position of the virtual task; and
a second display module, configured to display a small map in the virtual scene in response to that a display condition for the small map is satisfied, the target position being displayed in the small map.

An aspect described herein provides an electronic device for processing interaction data of a virtual scene, including:
a memory, configured to store a computer program or computer-executable instructions; and
a processor, configured to implement, when executing the computer program or computer-executable instructions stored in the memory, the method for processing interaction data of a virtual scene according to the aspects described herein.

An aspect described herein provides a computer-readable storage medium, having a computer program or computer-executable instructions stored therein, the computer program or computer-executable instructions, when executed by a processor, implementing the method for processing interaction data of a virtual scene according to the aspects described herein.

An aspect described herein provides a computer program product, including a computer program or computer-executable instructions, the computer program or computer-executable instructions, when executed by a processor, implementing the method for processing interaction data of a virtual scene according to the aspects described herein.

The aspects described herein have the following beneficial effects.

The small map is displayed in the virtual scene only when the display condition for the small map is satisfied, thereby avoiding that the small map is always displayed in the virtual scene. Compared with a solution in the related art in which the small map is always displayed, the aspects described herein can avoid a problem that the small map occupies display space, thereby simplifying information display in the virtual scene and improving utilization of display resources.

### BRIEF DESCRIPTION OF THE DRAWINGS

FIG. 1A is a schematic diagram of a first application mode of a method for processing interaction data of a virtual scene according to an aspect described herein.

FIG. 1B is a schematic diagram of a second application mode of a method for processing interaction data of a virtual scene according to an aspect described herein.

FIG. 2 is a schematic structural diagram of an electronic device according to an aspect described herein.

FIG. 3A is a first schematic flowchart of a method for processing interaction data of a virtual scene according to an aspect described herein.

FIG. 3B is a second schematic flowchart of a method for processing interaction data of a virtual scene according to an aspect described herein.

FIG. 3C is a third schematic flowchart of a method for processing interaction data of a virtual scene according to an aspect described herein.

FIG. 3D is a fourth schematic flowchart of a method for processing interaction data of a virtual scene according to an aspect described herein.

FIG. 4A is a first schematic diagram of an indicator according to an aspect described herein.

FIG. 4B is a second schematic diagram of an indicator according to an aspect described herein.

FIG. 4C is a third schematic diagram of an indicator according to an aspect described herein.

FIG. 4D is a fourth schematic diagram of an indicator according to an aspect described herein.

FIG. 4E is a schematic diagram of a small map according to an aspect described herein.

FIG. 4F is a schematic diagram of a candidate teleportation manner according to an aspect described herein.

FIG. 5 is a schematic flowchart of a method for processing interaction data of a virtual scene according to an aspect described herein.

FIG. 6 is a schematic flowchart of an indicator according to an aspect described herein.

FIG. 7 is a schematic diagram of a small map according to an aspect described herein.

FIG. 8 is a schematic diagram of a teleportation manner according to an aspect described herein.

FIG. 9 is a schematic diagram of teleporting a virtual object according to an aspect described herein.

### DETAILED DESCRIPTION

To make the objectives, technical solutions, and advantages described herein clearer, the following further describes various aspects in detail with reference to the accompanying drawings. The described aspects are not to be considered as a limitation but as illustrative. All other aspects obtained by a person of ordinary skill in the art without creative efforts shall fall within the protection scope described herein.

In the following descriptions, the term “first/second” involved is merely used for distinguishing between similar objects and does not represent a specific order of objects. A specific order or sequence of “first/second” is interchangeable when allowed, so that the aspects described herein described herein can be implemented in an order other than those illustrated or described herein.

In the following descriptions, related “some aspects” describe a subset of all possible aspects. However, the “some aspects” may be the same subset or different subsets of all the possible aspects, and may be combined with each other without conflict.

Unless otherwise defined, meanings of all technical and scientific terms used herein are the same as those usually understood by a person skilled in the relevant art. Terms used herein are merely intended to describe the aspects described herein, and are not intended as limiting.

In the aspect described herein, the term “module” or “unit” refers to a computer program with a preset function or a part of the computer program that works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including the module or unit function.

In the aspects described herein, relevant data related to user information is involved. When the aspects described herein are applied to specific products or technologies, user permission or consent is required, and the collection, use, and processing of relevant data need to comply with relevant laws, regulations, and standards.

Before the aspects described herein are further described in detail, terms involved in the aspects described herein are described. The terms involved in the aspects described herein are applicable to the following explanations.
(1) In response to: It is configured for representing a condition or state on which a performed operation depends. When the condition or state on which the performed operation depends is satisfied, one or more performed operations may be performed in real time, or may be performed after a set delay. Unless particularly described, a plurality of performed operations are not limited to an execution sequence.
(2) Client: It is an application providing various services run in a terminal, such as a video playback client and a game client.
(3) Virtual scene: It is a virtual game scene displayed (or provided) when a game application is run on a terminal. The virtual scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene. A dimension of the virtual scene is not limited in the aspects described herein. For example, the virtual scene may include the sky, the land, the ocean, or the like. The land may include environmental elements such as the desert and a city. A user may control a virtual object to move in the virtual scene.
(4) Virtual object: It is an image of various people and objects that is interactable in a virtual scene, or is a movable object in the virtual scene. The movable object may be a virtual person, a virtual animal, a cartoon character, or the like, for example, a person or an animal displayed in the virtual scene. The virtual object may be a virtual character configured for representing a user in the virtual scene. The virtual scene may include a plurality of virtual objects, and each virtual object has a shape and a volume in the virtual scene and occupies some space in the virtual scene.
(5) Large map: It is configured for presenting a complete game world (that is, a virtual scene), and a player can learn a position of the player and all positions included in the entire game world from a God's-eye view.
(6) Small map: It is a map that helps a player determine a position of a virtual object controlled by the player in a game world, and occupies only some display areas in a human-computer interaction interface. The small map presents only a part of the game world in the virtual scene, is configured for real-time directions and feedback information, and can help the player quickly learn the position of the player in the game world and a surrounding geographical environment during a game.
(7) Scene data: It indicates various features represented by a virtual object in a virtual scene in an interaction process, for example, may include a position of the virtual object in the virtual scene. Certainly, different types of features may be included based on a type of virtual scene. For example, in a virtual scene of a game, scene data may include waiting time of various functions configured in the virtual scene (depending on a quantity of times of the same function that can be used in a specific time), and may also represent attribute points of various states of game characters, including, for example, a health point (also referred to as a red point) and a magic point (also referred to as a blue point).

The aspects described herein provide a method and apparatus for processing interaction data of a virtual scene, an electronic device, a computer-readable storage medium, and a computer program product, which can save display space of a small map. For ease of understanding the method for processing interaction data of a virtual scene provided in the aspects described herein, an illustrative implementation scenario of the method for processing interaction data of a virtual scene provided in the aspects described herein is first described. A virtual scene in the method for processing interaction data of a virtual scene provided in the aspects described herein can be outputted completely based on the terminal, or outputted collaboratively based on the terminal and a server.

In some aspects, the virtual scene may be an environment for game characters to interact, for example, for game characters to battle in the virtual scene. By controlling an action of the game character, two parties can interact in the virtual scene, thus enabling users to relieve life stress during the game.

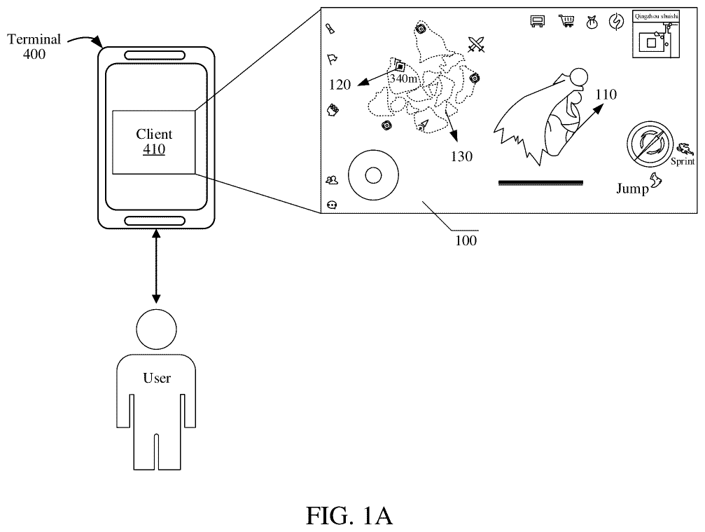

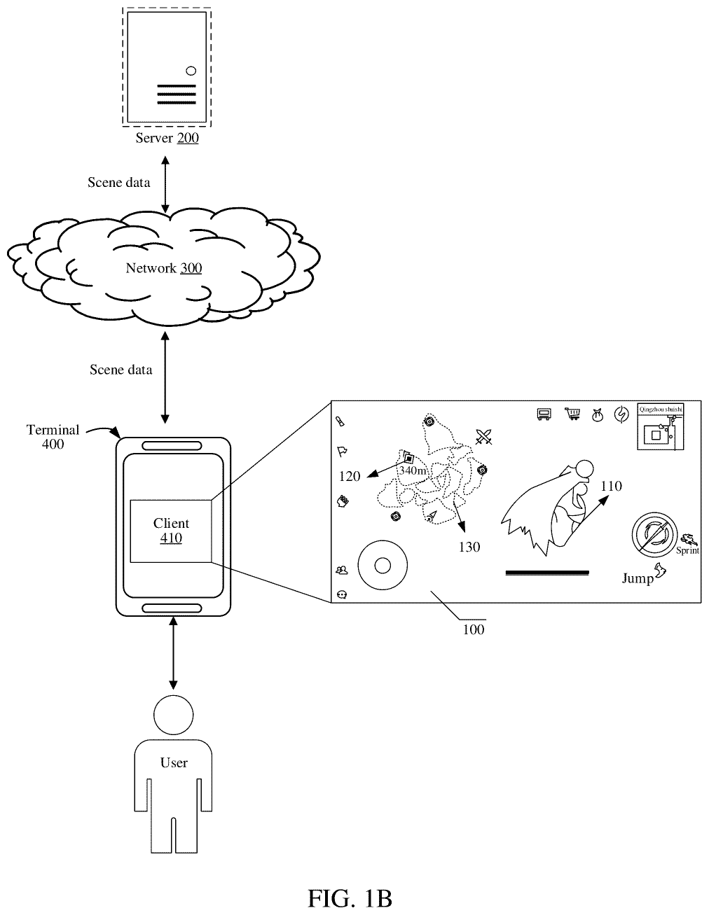

In an implementation scenario, FIG. 1A is a schematic diagram of an application mode of a method for processing interaction data of a virtual scene according to an aspect described herein, which is applicable to some application modes of completely relying on computing power of graphics processing hardware of a terminal 400 to complete calculation of related data of a virtual scene 100. For example, in a game in a stand-alone/an off-line mode, outputting of the virtual scene is completed through various types of terminals 400 such as a smartphone, a tablet computer, and a virtual reality/augmented reality device.

For example, types of graphics processing hardware include a central processing unit (CPU) and a graphics processing unit (GPU).

When forming visual perception of the virtual scene 100, the terminal 400 calculates data needed for display by using graphics computing hardware, completes loading, parsing, and rendering of display data, and outputs a video frame that can form the visual perception of the virtual scene by using graphics output hardware, for example, a two-dimensional video frame is displayed on a display screen of the smartphone, or a video frame for implementing a three-dimensional display effect is projected on lenses of augmented reality/virtual reality glasses. In addition, to enrich a perception effect, the terminal 400 may alternatively use different hardware to form one or more of auditory perception, tactile perception, motion perception, and taste perception.

In an example, a client 410 (for example, a stand-alone game application) is run on the terminal 400, and a virtual scene including a virtual object is outputted in a running process of the client 410. The virtual scene may be an environment for game characters to interact, for example, may be a plain, a street, and a valley for the game characters to battle with each other, or may be a room for the game characters to build. Using an example in which the virtual scene 100 is displayed from a third-person perspective, a virtual object 110, an indicator 120, and a small map 130 are displayed in the virtual scene 100. The virtual object 110 may be a game character that is controlled by a user (or referred to as a player). In other words, the virtual object 110 is controlled by a real user and is to operate in the virtual scene in response to an operation performed by the real user on a button (including a joystick button, an attack button, a defense button, and the like). For example, when the real user moves the joystick button to the left, the virtual object is to move to the left in the virtual scene. In addition, the virtual object may remain still, jump, and use various functions (such as a skill and an item).

For example, the virtual object 110 controlled by the player is displayed in the virtual scene 100. In response to a trigger operation of a virtual task in the virtual scene 100, the indicator 120 of the virtual task is displayed in the virtual scene 100. The indicator 120 is configured for pointing from a current position of the virtual object 110 to a target position of the virtual task. The small map 130 is displayed in the virtual scene 100 in response to that a display condition for the small map is satisfied. The target position is displayed in the small map. The player may control, based on the displayed small map, the virtual object 110 to head to the target position. Because the small map is not always displayed in the virtual scene, and the small map is displayed in the virtual scene only when the display condition is satisfied, the small map is prevented from occupying display space, information display in the virtual scene is simplified, and user experience is improved.

In another implementation scenario, FIG. 1B is a schematic diagram of an application mode of a method for processing interaction data of a virtual scene according to an aspect described herein, is applied to a terminal 400 and a server 200, and is applicable to an application mode in which computing of the virtual scene is completed depending on computing power of the server 200 and the virtual scene is outputted in the terminal 400.

Using an example in which visual perception of a virtual scene 100 is formed, the server 200 calculates related display data (for example, scene data) of the virtual scene, and sends the display data to the terminal 400 through a network 300. The terminal 400 depends on graphics computing hardware to complete loading, parsing, and rendering of calculation of the display data, and depends on graphics output hardware to output the virtual scene to form the visual perception, for example, a two-dimensional video frame may be displayed on a display screen of a smartphone, or a video frame for implementing a three-dimensional display effect is projected on lenses of augmented reality/virtual reality glasses. For perception of a form of the virtual scene, related hardware of the terminal 400 may be used for output, for example, a microphone is used to form auditory perception, and a vibrator is used to form tactile perception.

In an example, a client 410 (for example, an online game application) is run on the terminal 400, and is connected to a server 200 (for example, a game server) to interact with other users, and the terminal 400 outputs the virtual scene 100 of the client 410. Using an example in which the virtual scene 100 is displayed from a third-person perspective, a virtual object 110, an indicator 120, and a small map 130 are displayed in the virtual scene 100. The virtual object 110 may be a game character that is controlled by a user (or referred to as a player) In other words, the virtual object 110 is controlled by a real user and is to operate in the virtual scene in response to an operation performed by the real user on a button (including a joystick button, an attack button, a defense button, and the like). For example, when the real user moves the joystick button to the left, the virtual object is to move to the left in the virtual scene. In addition, the virtual object may remain still, jump, and use various functions (such as a skill and an item).

For example, the terminal 400 outputs the virtual scene 100 sent by the server 200, displays, in the virtual scene 100, the virtual object 110 controlled by the player, and displays the indicator 120 of a virtual task in the virtual scene 100 in response to a trigger operation of the virtual task in the virtual scene 100. The indicator 120 is configured for pointing from a current position of the virtual object 110 to a target position of the virtual task. The small map 130 is displayed in the virtual scene 100 in response to that a display condition for the small map is satisfied. The target position is displayed in the small map. The player may control, based on the displayed small map, the virtual object 110 to head to the target position. Because the small map is not always displayed in the virtual scene, and the small map is displayed in the virtual scene only when the display condition is satisfied, the small map is prevented from occupying display space, information display in the virtual scene is simplified, and user experience is improved.

In some aspects, the terminal 400 may implement the method for processing interaction data of a virtual scene provided in the aspects described herein by running a computer program. For example, the computer program may be an original program or a software module in an operating system, or may be a native application (APP), that is, a program that needs to be installed in the operating system to run, for example, a battle game APP (that is, the foregoing client 410), or may be a mini program that can be embedded in any APP, that is, a program that only needs to be downloaded to a browser environment to run. The computer program may be any form of application, module, or plug-in.

Using an example in which the computer program is an application, during actual implementation, an application supporting a virtual scene is installed and run on the terminal 400. The application may be any one of a first-person shooting (FPS) game, a third-person shooting game, a virtual reality application, a three-dimensional map program, or a multiplayer gunfight survival game. The user uses the terminal 400 to control the virtual object located in the virtual scene to perform an activity. The activity includes but is not limited to at least one of adjusting a body pose, crawling, walking, running, riding, jumping, driving, picking, shooting, attacking, throwing, and constructing a virtual building. For example, the virtual object may be a virtual person, such as a simulated character or an animation character.

In some aspects, the aspects described herein may alternatively be implemented by using a cloud technology. The cloud technology refers to a hosting technology that unifies a series of resources such as hardware, software, and networks within a wide area network or a local area network to implement calculation, storage, processing, and sharing of data.

The cloud technology is a generic term of a network technology, an information technology, an integration technology, a management platform technology, and an application technology based on application of a cloud computing business mode, and may form a resource pool and are used on demand flexibly and conveniently. The cloud computing technology will become an important support. Backend services of a technology network system require a lot of computing and storage resources.

For example, the server 200 in FIG. 1B may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smart watch, or the like, but is not limited thereto. The terminal 400 and the server 200 may be directly or indirectly connected in a wired or wireless communication manner. This is not limited in the aspects described herein.

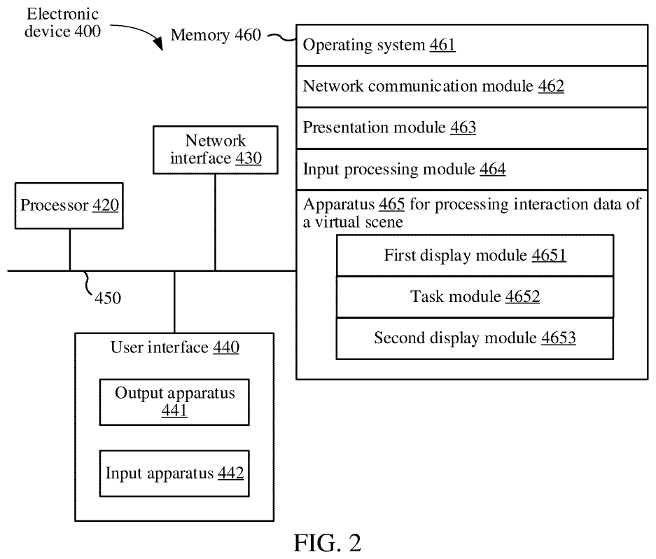

FIG. 2 is a schematic structural diagram of an electronic device according to an aspect described herein. An example in which the electronic device is a terminal 400 is used for description. The electronic device 400 shown in FIG. 2 includes at least one processor 420, a memory 460, at least one network interface 430, and a user interface 440. Components in the terminal 400 are coupled together via a bus system 450. The bus system 450 is configured to implement connection and communication between the components. In addition to a data bus, the bus system 450 further includes a power bus, a control bus, and a status signal bus. However, for clarity of description, all types of buses in FIG. 2 are marked as the bus system 450.

The processor 420 may be an integrated circuit chip having a signal processing capability, such as a general-purpose processor, a digital signal processor (DSP), or another programmable logic device, a discrete gate or transistor logic device, or a discrete hardware component. The general-purpose processor may be a microprocessor, any conventional processor, or the like.

The user interface 440 includes one or more output apparatuses 441 that can present media content, including one or more speakers and/or one or more visual display screens. The user interface 440 further includes one or more input apparatuses 442, including a user interface component that facilitate user input such as a keyboard, a mouse, a microphone, a touch display screen, a camera, another input button, or a control.

The memory 460 may be a removable memory, a non-removable memory, or a combination thereof. An illustrative hardware device includes a solid memory, a hard disk drive, an optical disk drive, and the like. The memory 460 illustratively includes one or more storage devices away from the processor 420 in physical positions.

The memory 460 includes a volatile memory or a non-volatile memory, or may include both volatile and non-volatile memories. The non-volatile memory may be a read-only memory (ROM), and the volatile memory may be a random access memory (RAM). The memory 460 described in this aspect described herein is to include any suitable type of memory.

In some aspects, the memory 460 may store data to support various operations. Examples of the data include a program, a module, and a data structure or a subset or superset thereof, which are illustratively described below.

An operating system 461 includes system programs for processing various basic system services and executing hardware-related tasks, such as a framework layer, a core library layer, and a driver layer, to implement various basic services and process hardware-based tasks.

A network communication module 462 is configured to reach another computing device through one or more (wired or wireless) network interfaces 430. Illustrative network interfaces 430 include: Bluetooth, wireless compatible authentication (Wi-Fi), a universal serial bus (USB), and the like.

A presentation module 463 is configured to enable presentation of information (for example, a user interface for operating peripheral devices and displaying content and information) through one or more output apparatuses 441 (for example, a display screen or a speaker) associated with the user interface 440.

An input processing module 464 is configured to: detect one or more user inputs or interactions from one or more input apparatuses 442, and translate the detected inputs or interactions.

In some aspects, an apparatus for processing interaction data of a virtual scene provided in the aspects described herein may be implemented by using software. FIG. 2 shows an apparatus 465 for processing interaction data of a virtual scene stored in the memory 460, which may be software in a form of a program, a plug-in, or the like, and includes the following software modules: a first display module 4651, a task module 4652, and a second display module 4653. The modules are logical and may be combined or further split in different manners depending on functions implemented. In FIG. 2, for ease of description, all of the foregoing modules are shown at a time. However, it is not to be considered that, the implementation in which the apparatus 465 for processing interaction data of a virtual scene may include only the first display module 4651, the task module 4652, and the second display module 4653 is excluded. Functions of the modules are described below.

In some other aspects, the apparatus for processing interaction data of a virtual scene provided in the aspects described herein may be implemented by using hardware. For example, the apparatus for processing interaction data of a virtual scene provided in the aspects described herein may be a processor in a form of a hardware decoding processor, programmed to perform the method for processing interaction data of a virtual scene provided in the aspects of the application. For example, the processor in the form of a hardware decoding processor may use one or more application specific integrated circuits (ASIC), a digital signal processor (DSP), a programmable logic device (PLD), a complex programmable logic device (CPLD), a field-programmable gate array (FPGA), or other electronic elements.

The following describes in detail the method for processing interaction data of a virtual scene provided in the aspects described herein with reference to the accompanying drawings. The method for processing interaction data of a virtual scene provided in the aspects described herein may be independently performed by the terminal 400 in FIG. 1A, or may be jointly performed by the terminal 400 and the server 200 in FIG. 1B.

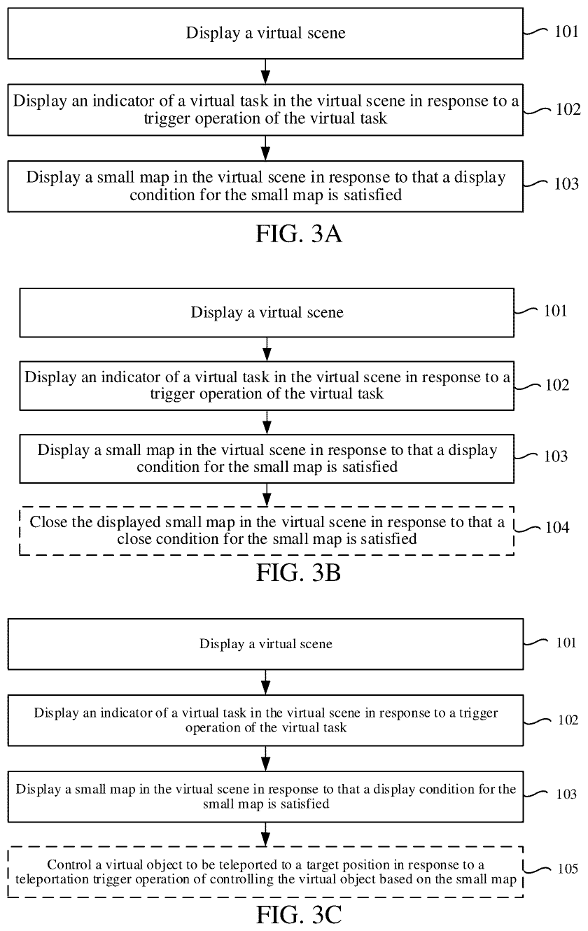

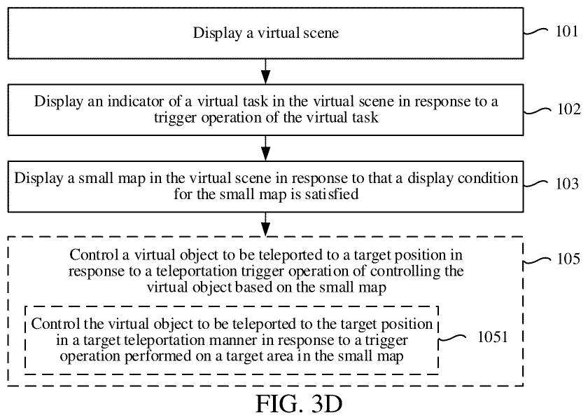

The following is described by using an example in which the method for processing interaction data of a virtual scene provided in the aspects described herein is performed independently by the terminal 400 in FIG. 1A. FIG. 3A is a schematic flowchart of a method for processing interaction data of a virtual scene according to an aspect described herein. Descriptions are provided with reference to operations shown in FIG. 3A.

The method shown in FIG. 3A may be performed by computer programs in various forms run on the terminal 400, and is not limited to the foregoing client 410. The method may alternatively be performed by the foregoing operating system 461, the software module, and a script. Therefore, the client is not considered as a limitation to this aspect described herein.

In operation 101, a virtual scene is displayed, where the virtual scene includes a virtual object.

The virtual object is displayed in the virtual scene, and the virtual object may be a game character that is controlled by a user (or referred to as a player). The virtual scene including the virtual object is a main interface of a game.

In operation 102, an indicator of a virtual task is displayed in the virtual scene in response to a trigger operation of the virtual task, where the indicator is configured for pointing from a current position of the virtual object to a target position of the virtual task.

The target position may be a location for the virtual object to execute the virtual task. For example, the virtual task is to reach the target position to execute a particular task, and the virtual task is completed only when the virtual object reaches the target position and executes the specific task at the target position. The target position may alternatively be a location to which the virtual task instructs the virtual object to head. For example, the virtual task is that the virtual object heads to the target position, and when the virtual object reaches the target position, the virtual task is completed.

The virtual task may be triggered from the virtual scene. In other words, in response to the trigger operation of the virtual task in the virtual scene, the indicator of the virtual task is displayed in the virtual scene, to complete the trigger operation of the virtual task and indication of the virtual task in the virtual scene, to avoid jumping to a large map to complete the trigger operation of the virtual task and the indication of the virtual task, thereby simplifying an interaction operation and improving interaction efficiency. The virtual task may alternatively be triggered from another interface (not the virtual scene including the virtual object, that is, not the main interface), for example, a large map interface. After the trigger operation of the virtual task is received, the indicator of the virtual task is displayed in the virtual scene, to complete the indication of the virtual task in the virtual scene, and avoid jumping to the large map to complete the indication of the virtual task, thereby simplifying the interaction operation and improving the interaction efficiency. The trigger operation of the virtual task in this aspect described herein may be an operation of directly triggering the virtual task (for example, clicking/tapping on the virtual task). The trigger operation of the virtual task in this aspect described herein may alternatively be implemented by triggering another icon or control in the virtual scene. The another icon or control is an icon or control associated with the virtual task in the virtual scene. A form of the trigger operation is not limited in this aspect described herein, and may be a form such as a click/tap, a double-click/tap, or a long press.

A form of the indicator is not limited in this aspect described herein. For example, the indicator may be in a form such as a rhombus or a rectangle.

In some aspects, operation 102 may be implemented in the following manner: displaying the indicator of the virtual task at a first position in the virtual scene in response to the trigger operation of the virtual task, where the first position is located on a forward route between the current position and the target position. In this way, the indicator of the virtual task is displayed on the forward route of the virtual object, so that the indicator can be viewed in time and quickly in a process of controlling the virtual object to advance, thereby quickly determining the target position of the virtual task, and improving the interaction efficiency.

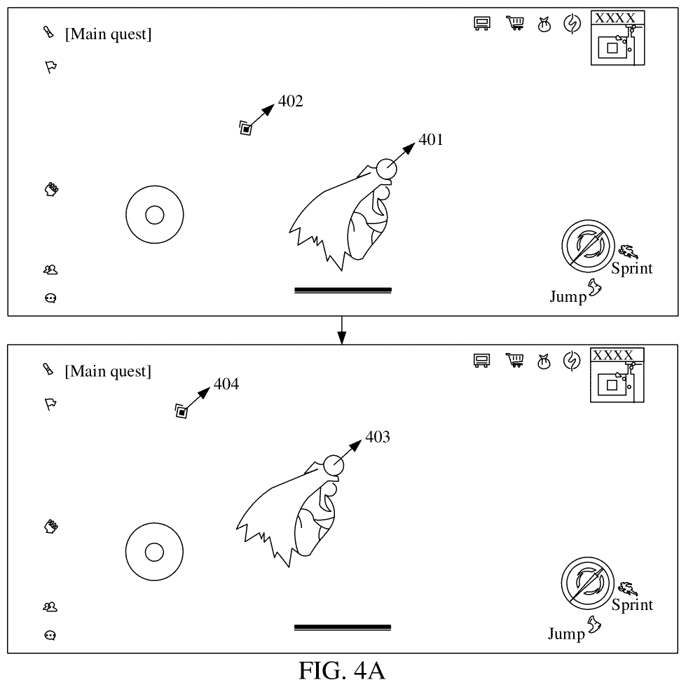

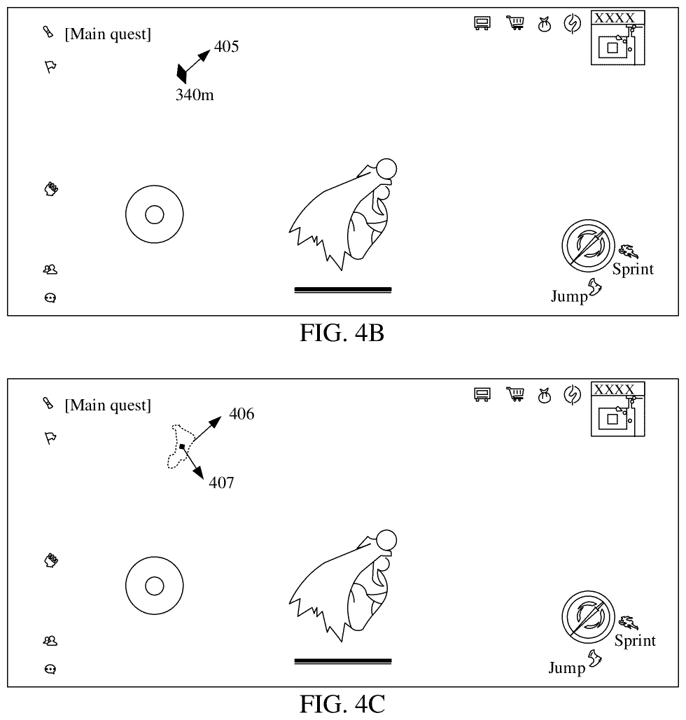

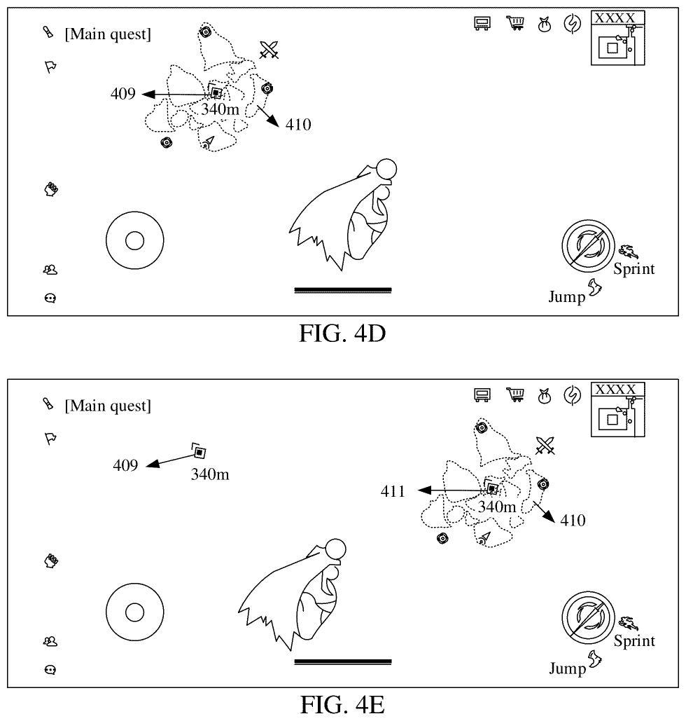

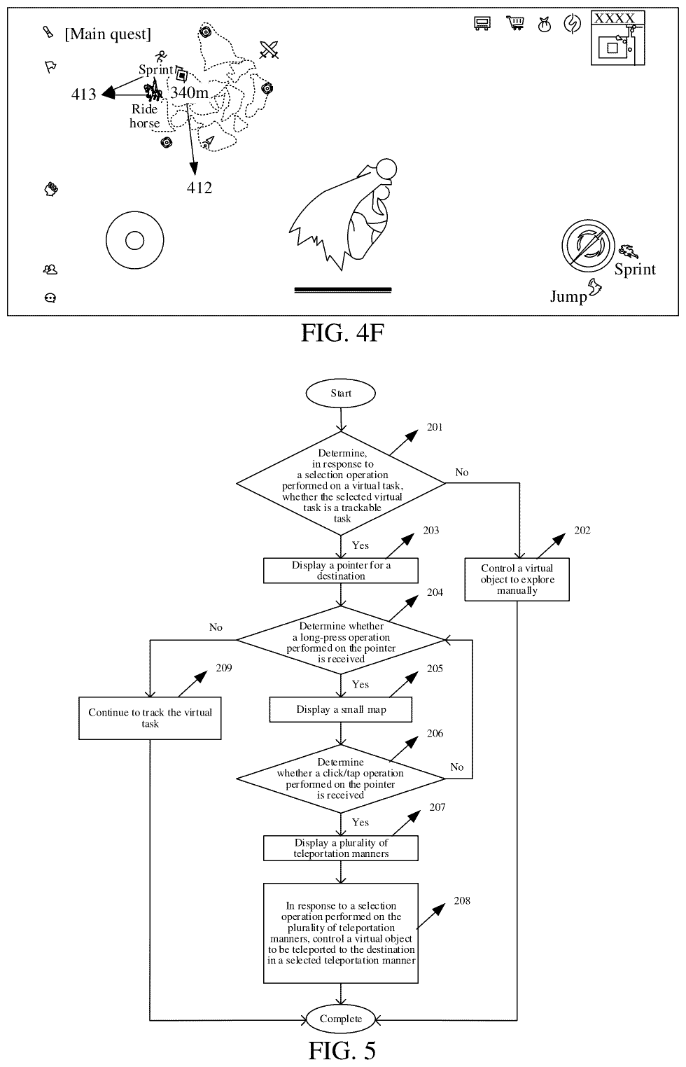

The first position is a position that has not been reached by the virtual object. The first position may move with movement of the virtual object, and guide the virtual object to move to the target position by moving with the movement. As shown in FIG. 4A, when the virtual object is located at a position 401, the indicator is located at a first position 402, and when the virtual object moves to a position 403, the indicator simultaneously moves to a first position 404. The form of the trigger operation of the virtual task is not limited in this aspect described herein, and may be a form such as a click/tap, a double-click/tap, or a long press.

In some aspects, operation 102 may be implemented in the following manner: in response to the trigger operation of the virtual task, when the target position is not displayed in the virtual scene, displaying, in a first display style in the virtual scene, the indicator carrying a first distance, where the first distance is a distance between the current position of the virtual object and the target position; and displaying the indicator in a second display style at the target position when the target position is displayed in the virtual scene, where the first display style is different from the second display style. In this way, when the target position is not displayed in the virtual scene, the indicator carrying the first distance is displayed in the virtual scene, so that the distance between the current position of the virtual object and the target position is learned by using the indicator. When the target position is displayed in the virtual scene, the distance between the current position of the virtual object and the target position can be intuitively learned according to the displayed target position, so that the first distance does not need to be displayed in the virtual scene, thereby simplifying information display in the virtual scene, and improving utilization of display resources.

A display parameter of the first display style includes at least one of the following: a color, a size, a shape, or a special effect. A display parameter of the second display style also includes at least one of the following: a color, a size, a shape, or a special effect. Whether the target position is displayed in the virtual scene is distinguished based on that the first display style is different from the second display style. For example, the first display style is red, and the second display style is green. Therefore, when the target position is not displayed in the virtual scene, a red indicator carrying the first distance is displayed in the virtual scene. When the target position is displayed in the virtual scene, a green indicator is displayed at the target position.

As shown in FIG. 4B, when the target position is not displayed in the virtual scene, a rhombic (that is, the first display style) indicator 405 is displayed in the virtual scene. The indicator 405 carries the distance (for example, “340 m” in FIG. 4B) between the current position of the virtual object and the target position. As shown in FIG. 4C, when a target position 406 is displayed in the virtual scene, a square (that is, the second display style) indicator 407 is displayed in the virtual scene.

In operation 103, the small map is displayed in the virtual scene in response to that the display condition for the small map is satisfied, where the target position is displayed in the small map.

The small map is not always displayed, and the small map is displayed in the virtual scene only when the display condition for the small map is satisfied, to guide the virtual object to head to the target position.

In some aspects, the display condition for the small map includes at least one of the following: receiving a trigger operation performed by a first account on the indicator, where the first account is an account that controls the virtual object; stay duration of the virtual object at the current position being greater than a stay duration threshold; in a process in which the virtual object heads to the target position, an increase of the distance between the current position and the target position being greater than an increase threshold; failing to reach, by the virtual object, the target position within first set duration; completing, by the virtual object, a virtual task at the current position; receiving, in a process of executing the virtual task by a specified quantity of second accounts, a trigger operation performed on the indicator, where the second account is an account other than the first account in the virtual scene; or receiving a prediction instruction returned by a first neural network model for displaying the small map.

In an example of the display condition, when the player manually performs the trigger operation on the indicator, that is, the electronic device receives the trigger operation performed by the first account on the indicator, the display condition for the small map is satisfied, and the small map is displayed in the virtual scene, to manually trigger display of the small map, to avoid a problem that the small map occupies display space, thereby simplifying information display in the virtual scene and improving utilization of display resources.

In an example of the display condition, when the stay duration of the virtual object at the current position is greater than the stay duration threshold, it indicates that the player might not know how to head to the target position, and the small map needs to be displayed to guide the player to control the virtual object to head to the target position. Therefore, when the stay duration of the virtual object at the current position is greater than the stay duration threshold, the small map is triggered to be displayed, so that the small map is displayed only when the player needs the small map to indicate the target position, to avoid a problem that the small map occupies display space, thereby simplifying information display in the virtual scene and improving utilization of display resources. The stay duration threshold represents maximum stay duration for which the small map is triggered to be displayed. The stay duration threshold may be a preset threshold and may be adjusted according to an actual requirement.

In an example of the display condition, in a process in which the virtual object heads to the target position, when the increase of the distance between the current position and the target position is greater than the increase threshold, it indicates that the virtual object controlled by the player is increasingly farther from the target position, the player may be disoriented, and the small map needs to be displayed for the player to view a route to the target position. Therefore, the small map is displayed only when the player is disoriented, to avoid a problem that the small map occupies display space, thereby simplifying information display in the virtual scene and improving utilization of display resources. The increase threshold represents a maximum increase for triggering display of the small map. The increase threshold may be a preset threshold and may be adjusted according to an actual requirement.

In an example of the display condition, when the virtual object fails to reach the target position within the first set duration, it indicates that the player may be unfamiliar with the route to the target position. The small map needs to be displayed for the player to view the small map to plan the route to the target position. Therefore, the small map is displayed only when the player is unfamiliar with the route to the target position, to avoid a problem that the small map occupies display space, thereby simplifying information display in the virtual scene and improving utilization of display resources. The first set duration may be duration that is preset according to an actual requirement.

In an example of the display condition, when the virtual object completes the virtual task at the current position, it indicates that the virtual object controlled by the player does not need to stay at the current position and needs to immediately head to the target position. Therefore, the small map is displayed in the virtual scene, so that the player views the small map and quickly heads to the target position.

In an example of the display condition, when the specified quantity of second accounts receive, in a process of executing the virtual task, the trigger operation performed on the indicator, where the second account is an account other than the first account in the virtual scene, it indicates that other users choose to display the small map in the virtual scene in a process of heading to the target position, and it indicates that the route to the target position may be relatively complex, and the small map needs to be displayed to assist the player in heading to the target position.

In an example of the display condition, when the prediction instruction returned by the first neural network model for displaying the small map is received, it indicates that the first neural network predicts that the small map needs to be displayed currently for the player to view the small map to plan the route to the target position. Therefore, the small map is manually triggered to be displayed, to avoid a problem that the small map occupies display space, thereby simplifying information display in the virtual scene and improving utilization of display resources.

In some aspects, the prediction instruction is obtained by using the first neural network model to perform the following processing: predicting the virtual task based on historical execution data of the first account for another virtual task, to obtain the prediction instruction for displaying the small map, where the another virtual task is a virtual task other than the virtual task in the virtual scene, the first neural network model is obtained through training by using historical execution data of a virtual task sample and an account sample of the virtual scene for another virtual task sample and a prediction instruction label, and the another virtual task sample is a virtual task other than the virtual task sample in the virtual scene.

A model structure of the first neural network model is not limited in this aspect described herein. For example, the first neural network model may be a convolutional neural network, a deep neural network, or the like.

Before the first neural network model is applied, an initial first neural network model needs to be trained, and then the trained first neural network model is applied. Whether the small map needs to be displayed is predicted by using an artificial intelligence technology in combination with a habit of the player. The first neural network model is obtained through training by using the historical execution data of the virtual task sample and the account sample of the virtual scene on the another virtual task sample and the prediction instruction label. For example, the initial first neural network model is invoked to perform prediction processing based on the historical execution data of the virtual task sample and the account sample of the virtual scene for the another virtual task sample, to obtain the prediction instruction for displaying the small map (for example, if the prediction instruction is 1, it indicates that the small map needs to be displayed; and if the prediction instruction is 0, the small map does not need to be displayed). After a value of a loss function of the first neural network model is determined by using the prediction instruction for displaying the small map and the prediction instruction label, whether the value of the loss function exceeds a preset threshold can be determined. When the value of the loss function exceeds the preset threshold, an error signal of the first neural network model is determined based on the loss function, error information is back-propagated in the first neural network model, and a model parameter of each layer is updated in a propagation process. A form of the loss function is not limited in this aspect described herein. For example, the loss function may be a cross-entropy loss function or an L2 loss function.

The back-propagation is described herein. Training sample data is inputted into an input layer of a neural network model, passes through a hidden layer, and finally reaches an output layer, and a result is outputted. This is a forward-propagation process of the neural network model. Because there is an error between an output result of the neural network model and an actual result, an error between the output result and an actual value is calculated, and the error is back-propagated from the output layer to the hidden layer until the error is propagated to the input layer. In a back-propagation process, a value of the model parameter is adjusted based on the error. That is, the loss function is constructed based on the error between the output result and the actual value, and a partial derivative of the loss function to the model parameter is obtained layer by layer, to generate a gradient of the loss function to the model parameter of each layer. Since a direction of the gradient indicates a direction of error expansion, the gradient of the model parameter is negated, to be added to an original parameter of each layer model, and an obtained summation result is used as the updated model parameter of each layer, to reduce the error caused by the model parameter. The foregoing process is continuously iterated until convergence is achieved. The first neural network model is a type of neural network model.

In some aspects, operation 103 may be implemented in the following manner: displaying the small map around the indicator in response to that the display condition for the small map is satisfied, where a center of the small map is one of the following: the indicator, the current position, or the target position. Therefore, additionally displaying a copy of the indicator in the small map is avoided, thereby simplifying information display in the virtual scene, and improving utilization of display resources.

In an example of displaying the small map around the indicator, as shown in FIG. 4D, in the virtual scene, the small map 410 is displayed around the indicator 409, and the indicator 409 is a center of the small map 410.

In some aspects, operation 103 may be implemented in the following manner: in response to that the display condition for the small map is satisfied, displaying the small map in some areas other than the indicator in the virtual scene, where the copy of the indicator is displayed in the small map, and the center of the small map is one of the following: the copy of the indicator, the current position, or the target position.

The copy of the indicator generally refers to an independent copy of the indicator displayed in the virtual scene, and is set for the player to quickly view a position of the indicator in the small map in the game.

In an example in which the small map is displayed in some areas other than the indicator in the virtual scene, as shown in FIG. 4E, the small map 410 is displayed in some areas other than the indicator 409 in the virtual scene, a copy 411 of the indicator is displayed in the small map 410, and the copy 411 of the indicator is a center of the small map 410.

FIG. 3B is another schematic flowchart of a method for processing interaction data of a virtual scene according to an aspect described herein. To prevent the small map from being always displayed and occupying display space, FIG. 3B shows that after operation 103 in FIG. 3A, the method further includes operation 104. In operation 104, in response to that a close condition for the small map is satisfied, the displayed small map is closed in the virtual scene. In this way, in this aspect described herein, the displayed small map is closed in the virtual scene when the close condition for the small map is satisfied, so that the small map is closed in time when the small map does not need to be displayed, thereby simplifying information display in the virtual scene and improving utilization of display resources.

In some aspects, the close condition for the small map includes at least one of the following: receiving a close operation performed by the first account on the small map, where the first account is an account that controls the virtual object; stay duration of the virtual object at the current position being less than or equal to a stay duration threshold; in the process in which the virtual object heads to the target position, a decrease of the distance between the current position and the target position being greater than a decrease threshold; reaching, by the virtual object, the target position; and failing to complete, by the virtual object, the virtual task at the current position.

In an example of the close condition, when the player manually closes the indicator, that is, the electronic device receives the close operation performed by the first account on the indicator, the display condition for the small map is satisfied, and the displayed small map is closed in the virtual scene, to manually close the small map.

In an example of the close condition, when the stay duration of the virtual object at the current position is less than or equal to the stay duration threshold, it indicates that the player clearly know how to head to the target position, and the small map does not need to be displayed to guide the player to control the virtual object to head to the target position. Therefore, when the stay duration of the virtual object at the current position is less than or equal to the stay duration threshold, the displayed small map is triggered to be closed. Therefore, when the player clearly knows how to head to the target position, the small map is closed in time, to avoid a problem that the small map occupies display space, thereby simplifying information display in the virtual scene and improving utilization of display resources. The stay duration threshold represents minimum stay duration for which the small map is triggered to be closed. The stay duration threshold may be a preset threshold and may be adjusted according to an actual requirement.

In an example of the close condition, in a process in which the virtual object heads to the target position, when the decrease of the distance between the current position and the target position is greater than the decrease threshold, it indicates that the virtual object controlled by the player is approaching the target position. The player clearly knows how to head to the target position, and the small map does not need to be displayed to guide the player to control the virtual object to head to the target position. Therefore, when the player clearly knows how to head to the target position, the small map is closed in time, to avoid a problem that the small map occupies display space, thereby simplifying information display in the virtual scene and improving utilization of display resources. The decrease threshold represents a minimum decrease for triggering closing of the small map. The decrease threshold may be a preset threshold and may be adjusted according to an actual requirement.

In an example of the close condition, when the virtual object reaches the target position, the small map does not need to be displayed to guide the player to control the virtual object to head to the target position, so that when the player reaches the target position, the small map is closed in time, to avoid a problem that the small map occupies display space, thereby simplifying information display in the virtual scene and improving utilization of display resources.

In an example of the close condition, when the virtual object fails to complete the virtual task at the current position, it indicates that the virtual object controlled by the player still stays at the current position, continues to execute the virtual task at the current position, and does not need to head to the target position immediately, that is, the small map does not need to be displayed to guide the player to control the virtual object to head to the target position. Therefore, the small map is closed in time when the player does not need to reach the target position temporarily, to avoid a problem that the small map occupies display space, thereby simplifying information display in the virtual scene and improving utilization of display resources.

FIG. 3C is still another schematic flowchart of a method for processing interaction data of a virtual scene according to an aspect described herein. When the virtual object needs to be quickly teleported to the target position, FIG. 3C shows that after operation 103 in FIG. 3A, the method further includes operation 105. In operation 105, the virtual object is controlled to be teleported to the target position in response to a teleportation trigger operation of controlling the virtual object based on the small map. Before the virtual object is controlled to be teleported to the target position, at least one of the following is displayed in the small map: a landform between the current position and the target position; a distance between the current position and the target position; and a route between the current position and the target position, so that the player can determine a teleportation manner of the virtual object according to the landform, the distance, and the route subsequently.

FIG. 3D is yet another schematic flowchart of a method for processing interaction data of a virtual scene according to an aspect described herein. FIG. 3D shows that operation 105 in FIG. 3C may be implemented through operation 1051. In operation 1051, in response to a trigger operation performed on a target area in the small map, the virtual object is controlled to be teleported to the target position in a target teleportation manner, where the target area is one of the following: the target position, the indicator, or the copy of the indicator. A type of the target teleportation manner includes one of the following: teleportation by riding in a virtual vehicle, walking teleportation, sprinting teleportation, or air teleportation. In this way, the trigger operation performed on the target area in the small map is used to control the virtual object to be teleported to the target position, thereby avoiding that the virtual object is teleported to the target position due to an accidental touch, to improve teleportation accuracy of the virtual object.

The teleportation by riding in a virtual vehicle represents controlling the virtual object to ride in a virtual vehicle to be teleported to the target position. The walking teleportation represents controlling the virtual object to be teleported to the target position in a walking manner. The sprinting teleportation represents controlling the virtual object to be teleported to the target position in a sprinting manner. The air teleportation represents controlling the virtual object to be teleported to the target position in an airborne manner. The virtual vehicle represents a vehicle in which the virtual object can ride, and is configured to move or execute a specific task in the virtual scene. A form of the virtual vehicle is not limited in this aspect described herein. For example, the virtual vehicle may be a virtual horse, a virtual car, a virtual plane, a virtual watercraft, a virtual motorcycle, or the like. The virtual vehicle may provide a faster moving speed, a stronger armor, a larger customer load, or another special function for the player in the game, to enhance game experience and a combat capability of the player.

In an example, when the target position is displayed in the small map, in response to the trigger operation performed on the target position in the small map, the virtual object is controlled to be teleported to the target position in the target teleportation manner. When the indicator is displayed in the small map, in response to a trigger operation performed on the indicator in the small map, the virtual object is controlled to be teleported to the target position in the target teleportation manner. When the copy of the indicator is displayed in the small map, in response to a trigger operation performed on the copy of the indicator in the small map, the virtual object is controlled to be teleported to the target position in the target teleportation manner.

In some aspects, operation 1051 may be implemented in the following manner: displaying at least one candidate teleportation manner in the virtual scene in response to the trigger operation performed on the target area in the small map. In response to a selection operation performed on the at least one candidate teleportation manner, a selected candidate teleportation manner is used as the target teleportation manner, and the virtual object is controlled to be teleported to the target position in the target teleportation manner. Therefore, an appropriate teleportation manner is selected to teleport the virtual object to the target position by manually selecting the target teleportation manner. A type of the at least one candidate teleportation manner includes at least one of the following: teleportation by riding in a virtual vehicle, walking teleportation, sprinting teleportation, or air teleportation.

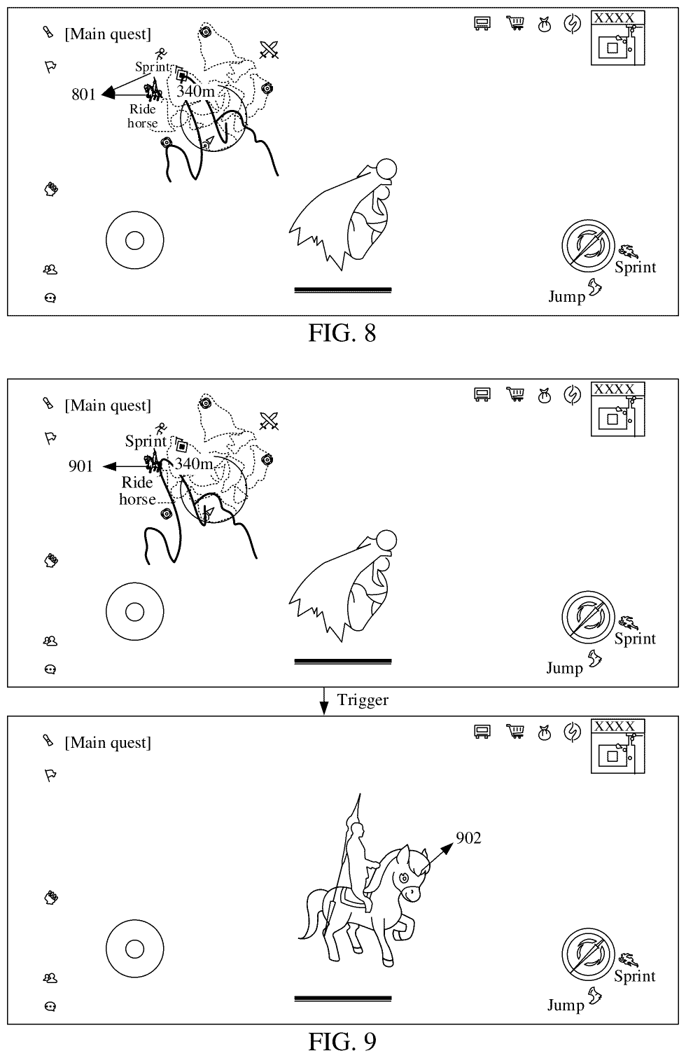

As shown in FIG. 4F, after the small map is displayed, when the trigger operation performed on the target area (for example, an indicator 412 shown in FIG. 8) is received, at least one candidate teleportation manner 413, such as horse riding teleportation, sprinting teleportation, or sword riding teleportation, is displayed around the target area in the virtual scene. In response to the selection operation performed on the at least one candidate teleportation manner, a selected candidate teleportation manner is used as the target teleportation manner, and the virtual object is controlled to be teleported to the target position in the target teleportation manner. For example, if the horse riding teleportation is selected, the virtual object is controlled to be teleported to the target position in a horse riding manner.

In some aspects, operation 1051 may be implemented in the following manner: determining a target teleportation manner from a plurality of candidate teleportation manners in response to the trigger operation performed on the target area in the small map; and controlling the virtual object to be teleported to the target position in the target teleportation manner. A type of the at least one candidate teleportation manner includes at least one of the following: teleportation by riding in a virtual vehicle, walking teleportation, sprinting teleportation, or air teleportation. Therefore, by automatically determining the target teleportation manner, an appropriate teleportation manner is automatically selected to teleport the virtual object to the target position, thereby simplifying an interaction operation and improving human-computer interaction efficiency.

In an example of determining the target teleportation manner, a matching candidate teleportation manner in the plurality of candidate teleportation manners is determined as the target teleportation manner. A type of the matching candidate teleportation manner includes at least one of the following: a candidate teleportation manner matching the distance between the current position and the target position, a candidate teleportation manner matching the landform between the current position and the target position, a candidate teleportation manner matching the virtual task at the current position, or a candidate teleportation manner matching the virtual task at the target position. For example, when the candidate teleportation manner is horse riding teleportation, sprinting teleportation, or sword riding teleportation, and when the distance between the current position and the target position is greater than a set distance, it indicates that the distance between the current position and the target position is long, the horse riding teleportation matching the distance between the current position and the target position is determined as the target teleportation manner, to control the virtual object to be quickly teleported to the target position in the horse riding manner. When the landform between the current position and the target position is a steep mountain peak, it indicates that the landform between the current position and the target position is not suitable for flat teleportation, and the sword riding teleportation matching the landform between the current position and the target position is determined as the target teleportation manner, to control the virtual object to be teleported to the target position in a sword riding manner. When the virtual task at the current position is a horse riding match, the candidate teleportation manner matching the virtual task at the current position is the horse riding teleportation. The virtual object needs to be controlled first to complete the virtual task at the current position by horse riding, and after the virtual task at the current position is completed, a virtual mount does not need to be changed, so that the virtual object can be quickly teleported to the target position. When the virtual task at the target position is a running match, the candidate teleportation manner matching the virtual task at the target position is the sprinting teleportation. The virtual object may be controlled to be teleported to the target position through the sprinting teleportation. After being teleported to the target position, an activity manner of the virtual object does not need to be changed, and the virtual object can quickly enter the running match.

In another example of determining the target teleportation manner, a second neural network model is invoked based on the first account that controls the virtual object, to perform prediction processing on the plurality of candidate teleportation manners, to obtain the target teleportation manner. The second neural network model is obtained through training by using an account sample, a candidate teleportation manner sample, and a target teleportation manner label.

A model structure of the second neural network model is not limited in this aspect described herein. For example, the second neural network model may be a convolutional neural network, a deep neural network, or the like.

Before the second neural network model is applied, an initial second neural network model needs to be trained, and then the trained second neural network model is applied. An appropriate target teleportation manner is predicted by using an artificial intelligence technology in combination with a habit of the player. The second neural network model is obtained through training by using the account sample, the candidate teleportation manner sample, and the target teleportation manner label. For example, the initial second neural network model is invoked to perform prediction processing based on the account sample and the candidate teleportation manner sample, to obtain a predicted target teleportation manner. After a value of a loss function of the second neural network model is determined by using the predicted target teleportation manner and the target teleportation manner label, whether the value of the loss function exceeds a preset threshold may be determined. When the value of the loss function exceeds the preset threshold, an error signal of the second neural network model is determined based on the loss function, error information is back-propagated in the second neural network model, and a model parameter of each layer is updated in a propagation process. A form of the loss function is not limited in this aspect described herein. For example, the loss function may be a cross-entropy loss function or an L2 loss function.

In another example of determining the target teleportation manner, a third neural network model is invoked based on the first account that controls the virtual object, the distance between the current position and the target position, and a landform between the current position and the target position, to perform prediction processing on the plurality of candidate teleportation manners, to obtain the target teleportation manner. The third neural network model is obtained through training by using an account sample, a distance sample, a landform sample, a candidate teleportation manner sample, and a target teleportation manner label.

A model structure of the third neural network model is not limited in this aspect described herein. For example, the third neural network model may be a convolutional neural network, a deep neural network, or the like.

Before the third neural network model is applied, an initial third neural network model needs to be trained, and then the trained third neural network model is applied. An appropriate target teleportation manner is predicted by using an artificial intelligence technology in combination with a habit of the player, the distance between the current position and the target position, and the landform between the current position and the target position. The third neural network model is obtained through training by using the account sample, the distance sample, the landform sample, the candidate teleportation manner sample, and the target teleportation manner label. For example, the initial third neural network model is invoked to perform prediction processing based on the account sample, the distance sample between the current position and the target position, the landform sample between the current position and the target position, and the candidate teleportation manner sample, to obtain a predicted target teleportation manner. After a value of a loss function of the third neural network model is determined by using the predicted target teleportation manner and the target teleportation manner label, whether the value of the loss function exceeds a preset threshold may be determined. When the value of the loss function exceeds the preset threshold, an error signal of the third neural network model is determined based on the loss function, error information is back-propagated in the third neural network model, and a model parameter of each layer is updated in a propagation process. A form of the loss function is not limited in this aspect described herein. For example, the loss function may be a cross-entropy loss function or an L2 loss function.

The following describes an illustrative application of this aspect described herein in an actual application scenario.

This aspect described herein can be applied to various virtual scenes, for example, in a virtual scene such as a game, and a real interaction process between virtual objects can be simulated.

With development of technologies and improvement of performance of electronic devices, an operation manner of a human-computer interaction interface certainly develops toward a more convenient and more efficient control manner, so that the user has more pleasant human-computer interaction experience.

An aspect described herein provides a method for processing interaction data of a virtual scene. A small map does not need to be always fixedly displayed in a virtual scene, thereby preventing the small map from occupying display space. In addition, when exploring the large world, a player can follow a pointer (also referred to as an indicator) of a virtual task to find a way, and trigger to display, at the pointer, the small map including a current position of a virtual object controlled by the player and a destination (also referred to as a target position), to subsequently select an appropriate teleportation manner according to the small map. Such an interaction manner can simplify an interaction operation, and significantly improve operation experience of the player.

FIG. 5 is a schematic flowchart of a method for processing interaction data of a virtual scene according to an aspect described herein. Descriptions are provided with reference to operations shown in FIG. 5.

Operation 201: Determine, in response to a selection operation performed on a virtual task, whether the selected virtual task is a trackable task; and when the virtual task is not a trackable task, perform operation 202, or when the virtual task is a trackable task, perform operation 203.

When a game is entered, whether the selected virtual task is a trackable task is detected in response to the selection operation performed on the virtual task in the game, that is, whether the selected virtual task can be tracked is detected.

Operation 202: Control a virtual object to explore manually.

When the virtual task is not a trackable task, it indicates that the controlled virtual object cannot quickly reach a destination because the virtual task cannot be tracked, and the virtual object can only be controlled to explore manually in the large world of the game.

Operation 203: Display a pointer for the destination.

For example, the pointer for the destination is displayed in a main interface (that is, a virtual scene including the virtual object). The pointer is configured for indicating a direction, where the direction represents a direction from a current position of a virtual object controlled by a player to a destination, and the pointer further carries a distance, where the distance represents a distance between the current position of the virtual object controlled by the player and the destination.

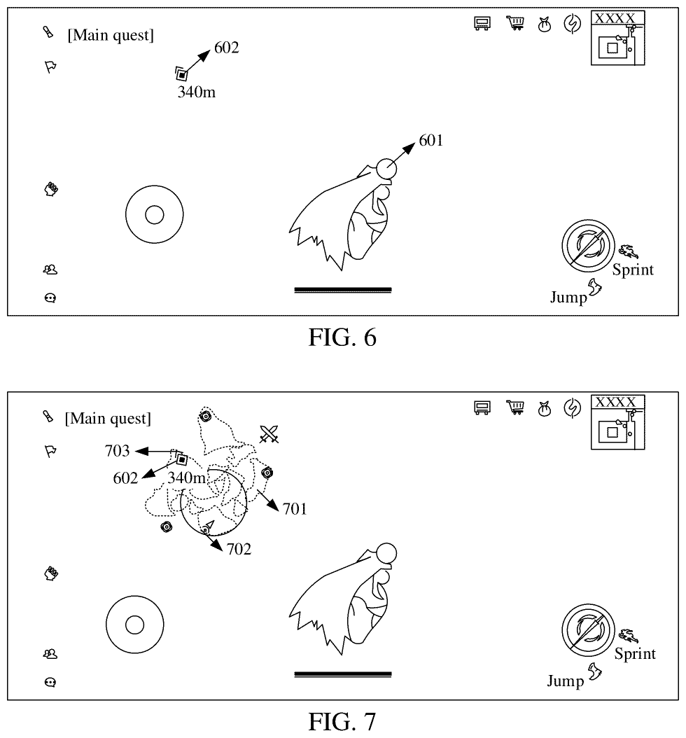

As shown in FIG. 6, a pointer 602 for a destination is displayed in a virtual scene including a virtual object 601. The pointer 602 is configured for indicating a direction from a current position of a virtual object controlled by a player to a destination, and “340 m” carried in the pointer 602 represents that a distance between the current position of the virtual object controlled by the player and the destination is 340 meters.

Operation 204: Determine whether a long-press operation performed on the pointer is received; and when the long-press operation performed on the pointer is received, perform operation 205, or when the long-press operation for the pointer is not received, perform operation 209.

After collecting event data, a processor of an electronic device may determine the event data as a long-press operation or a click/tap operation, to determine whether the long-press operation for the pointer is received.

Operation 205: Display a small map.

As shown in FIG. 7, when the long-press operation for the pointer 602 is received, a small map 701 is displayed around the pointer 602 in the virtual scene including the virtual object. The small map 701 includes a current position 702 and a destination 703 of the virtual object.

Operation 206: Determine whether a click/tap operation for the pointer is received; and when the click/tap operation for the pointer is received, perform operation 207, or when the click/tap operation for the pointer is not received, perform operation 205.

Operation 207: Display a plurality of teleportation manners.

As shown in FIG. 8, after the small map is displayed, and when the click/tap operation for the pointer is received, a plurality of teleportation manners 801, such as horse riding teleportation, sprinting teleportation, or sword riding teleportation, are displayed in the virtual scene including the virtual object.

The displayed plurality of teleportation manners may be determined based on the distance between the current position of the virtual object controlled by the player and the destination. For example, when the distance between the current position of the virtual object controlled by the player and the destination is greater than a set threshold, the displayed plurality of teleportation manners may be the horse riding teleportation and the sprinting teleportation.

Operation 208: In response to a selection operation performed on the plurality of teleportation manners, teleport the virtual object to the destination in a selected teleportation manner.

As shown in FIG. 9, in response to a selection operation performed on a teleportation manner 901, the virtual object is teleported to the destination in a selected teleportation manner 901 (namely, “horse riding” teleportation shown in FIG. 9), for example, a virtual vehicle 902 is called to control the virtual object to head to the destination in a horse riding manner.

After the selection operation performed on the plurality of teleportation manners is received, whether the selected teleportation manner is in effect may be determined. For example, when a virtual vehicle corresponding to the selected teleportation manner is loaded into the virtual scene, it is determined that the selected teleportation manner is in effect, and the virtual object is teleported to the destination through the selected teleportation manner. If the virtual vehicle corresponding to the selected teleportation manner is not loaded into the virtual scene, it is determined that the selected teleportation manner is not in effect, and the virtual vehicle corresponding to the selected teleportation manner needs to be loaded into the virtual scene first.

Operation 209: Continue to track the virtual task.

The virtual task continues to be tracked. To be specific, the pointer continues to be updated and displayed according to the direction from the current position of the virtual object controlled by the player to the destination, and the player is guided, through the updated pointer, to control the virtual object to head to the destination.

In conclusion, according to the method for processing interaction data of a virtual scene provided in this aspect described herein, the small map does not need to be always fixedly displayed, thereby preventing the small map from occupying display space and simplifying information display. In addition, a teleportation operation on the virtual object can be completed only in the main interface without jumping to a large map interface for performing the teleportation operation on the virtual object, thereby simplifying operations, significantly improving operation experience of the player, and providing more fun of the game.

The method for processing interaction data of a virtual scene provided in the aspects described herein is described in combination with illustrative applications and implementations of the electronic device provided in the aspects described herein by far. The following continues to describe that modules in an apparatus 555 for processing interaction data of a virtual scene provided in the aspects described herein cooperate to implement a scheme for processing interaction data of a virtual scene.

A first display module 5551 is configured to display a virtual scene, where the virtual scene includes a virtual object. A task module 5552 is configured to display an indicator of a virtual task in the virtual scene in response to a trigger operation of the virtual task, where the indicator is configured for pointing from a current position of the virtual object to a target position of the virtual task. A second display module 5553 is configured to display a small map in the virtual scene in response to that a display condition for the small map is satisfied, where the target position is displayed in the small map.

In some aspects, the task module 5552 is further configured to display the indicator of the virtual task at a first position in the virtual scene, where the first position is located on a forward route between the current position and the target position.

In some aspects, the task module 5552 is further configured to: when the target position is not displayed in the virtual scene, display, in a first display style in the virtual scene, the indicator carrying a first distance, where the first distance is a distance between the current position of the virtual object and the target position; and when the target position is displayed in the virtual scene, display the indicator in a second display style at the target position, where the first display style is different from the second display style.

In some aspects, the display condition for the small map includes at least one of the following: receiving a trigger operation performed by a first account on the indicator, where the first account is an account that controls the virtual object; stay duration of the virtual object at the current position being greater than a stay duration threshold; in a process in which the virtual object heads to the target position, an increase of the distance between the current position and the target position being greater than an increase threshold; failing to reach, by the virtual object, the target position within first set duration; completing, by the virtual object, a virtual task at the current position; receiving, in a process of executing the virtual task by a specified quantity of second accounts, a trigger operation performed on the indicator, where the second account is an account other than the first account in the virtual scene; or receiving a prediction instruction returned by a first neural network model for displaying the small map.

In some aspects, the prediction instruction is obtained by using the first neural network model to perform the following processing: predicting the virtual task based on historical execution data of the first account for another virtual task, to obtain the prediction instruction for displaying the small map, where the another virtual task is a virtual task other than the virtual task in the virtual scene, the first neural network model is obtained through training by using historical execution data of a virtual task sample and an account sample of the virtual scene for another virtual task sample and a prediction instruction label, and the another virtual task sample is a virtual task other than the virtual task sample in the virtual scene.

In some aspects, the second display module 5553 is further configured to display the small map around the indicator, where a center of the small map is one of the following: the indicator, the current position, or the target position.

In some aspects, the second display module 5553 is further configured to display the small map in some areas other than the indicator in the virtual scene, where a copy of the indicator is displayed in the small map, and the center of the small map is one of the following: the copy of the indicator, the current position, and the target position.

In some aspects, after the small map is displayed in the virtual scene, the second display module 5553 is further configured to close the displayed small map in the virtual scene when a close condition for the small map is satisfied.

In some aspects, the close condition for the small map includes at least one of the following: receiving a close operation performed by the first account on the small map, where the first account is an account that controls the virtual object; stay duration of the virtual object at the current position being less than or equal to a stay duration threshold; in the process in which the virtual object heads to the target position, a decrease of the distance between the current position and the target position being greater than a decrease threshold; reaching, by the virtual object, the target position; and failing to complete, by the virtual object, the virtual task at the current position.

In some aspects, after the small map is displayed in the virtual scene, the second display module 5553 is further configured to control the virtual object to be teleported to the target position in response to a teleportation trigger operation of controlling the virtual object based on the small map.

In some aspects, the second display module 5553 is further configured to: control, in response to a trigger operation performed on a target area in the small map, the virtual object to be teleported to the target position in a target teleportation manner, where the target area is one of the following: the target position, the indicator, or the copy of the indicator.

In some aspects, before controlling the virtual object to be teleported to the target position in the target teleportation manner, the second display module 5553 is further configured to: display at least one candidate teleportation manner in the virtual scene; and in response to a selection operation performed on the at least one candidate teleportation manner, determine a selected candidate teleportation manner as the target teleportation manner.

In some aspects, before the controlling the virtual object to be teleported to the target position in the target teleportation manner, the second display module 5553 is further configured to determine the target teleportation manner from a plurality of candidate teleportation manners.

In some aspects, the second display module 5553 is further configured to determine a matching candidate teleportation manner in the plurality of candidate teleportation manners as the target teleportation manner, where a type of the matching candidate teleportation manner includes at least one of the following: a candidate teleportation manner matching the distance between the current position and the target position, a candidate teleportation manner matching a landform between the current position and the target position, a candidate teleportation manner matching the virtual task at the current position, or a candidate teleportation manner matching a virtual task at the target position.

In some aspects, the second display module 5553 is further configured to perform prediction processing on the plurality of candidate teleportation manners when the first account of the virtual object is controlled to invoke a second neural network model, to obtain the target teleportation manner, where the second neural network model is obtained through training by using an account sample, a candidate teleportation manner sample, and a target teleportation manner label.

In some aspects, the second display module 5553 is further configured to invoke a third neural network model to perform prediction processing on the plurality of candidate teleportation manners based on the first account of the virtual object, the distance between the current position and the target position, and a landform between the current position and the target position, to obtain the target teleportation manner, where the third neural network model is obtained through training by using an account sample, a distance sample, a landform sample, a candidate teleportation manner sample, and a target teleportation manner label.

In some aspects, before the controlling the virtual object to be teleported to the target position, the second display module 5553 is further configured to display at least one of the following in the small map: the landform between the current position and the target position; the distance between the current position and the target position; or the route between the current position and the target position.

An aspect described herein provides a computer program product. The computer program product includes a computer program or computer-executable instructions, and the computer program or the computer-executable instructions are stored in a computer-readable storage medium. A processor of an electronic device reads the computer program or the computer-executable instructions from the computer-readable storage medium. The processor executes the computer program or the computer-executable instructions, to cause the electronic device to perform the method for processing interaction data of a virtual scene in the aspects described herein.

An aspect described herein provides a computer-readable storage medium, having computer-executable instructions or a computer program stored therein. When executed by a processor, the computer-executable instructions or the computer program causes the processor to perform the method for processing interaction data of a virtual scene provided in the aspects described herein, for example, the method for processing interaction data of a virtual scene shown in FIG. 3A to FIG. 3D.

In some aspects, the computer-readable storage medium may be a memory such as a ferroelectric random access memory (FRAM), a ROM, a programmable read-only memory (PROM), an erasable programmable read-only memory (EPROM), an electrically erasable programmable read-only memory (EEPROM), a flash memory, a magnetic surface memory, an optical disk, or a compact disc read-only memory (CD-ROM); or may be any device including one of or any combination of the foregoing memories.

In some aspects, the computer-executable instructions may be written in a form of a program, software, a software module, a script, or code and according to a programming language (including a compiled or interpreted language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in a plurality of collaborative files (for example, be stored in files of one or more modules, subprograms, or code parts).

In an example, the computer-executable instructions may be deployed to be executed on one electronic device, on a plurality of electronic devices located at one location, or on a plurality of electronic devices distributed at a plurality of locations and interconnected through a communication network.

The foregoing descriptions are only aspects described herein and are not intended to limit the scope of protection described herein. Any modification, equivalent replacement, and improvement made within the spirit and scope described herein fall within the protection scope described herein.

What is claimed is:

1. A computer implemented method, comprising:
displaying a virtual scene, the virtual scene comprising a virtual character;
displaying an indicator of a virtual task in the virtual scene when a predetermined virtual task condition is met, the indicator being configured for pointing from a current position of the virtual character to a target position of the virtual task; and
displaying a map within a portion of the virtual scene when a predetermined map condition is satisfied, wherein the target position is displayed in the map.

2. The method of claim 1, wherein the displaying the indicator comprises:
displaying the indicator of the virtual task at a first position within the virtual scene, the first position being located on a forward route between the current position and the target position.

3. The method of claim 1, wherein the displaying the indicator comprises:
displaying, in a first display style in the virtual scene when the target position is not displayed in the virtual scene, the indicator indicating a first distance, the first distance representing a distance between the current position of the virtual character and the target position; and
displaying the indicator in a second display style at the target position when the target position is displayed in the virtual scene, the first display style being different from the second display style.

4. The method of claim 1, wherein the predetermined map condition comprises one or more of:
receiving a trigger operation performed by a first account on the indicator, the first account being an account that controls the virtual character;
a stay duration of the virtual character at the current position being greater than a stay duration threshold;
after the virtual character initially heads toward the target position, an increase in the distance between the current position and the target position exceeds an increase threshold;
failing to reach, by the virtual object, the target position within a first set duration;
completing, by the virtual object, a virtual task at the current position;
receiving, in a process of executing the virtual task by one or more second accounts, a trigger operation performed on the indicator, each second account being an account in the virtual scene other than the first account; or
receiving a prediction instruction returned by a neural network model for displaying the map.

5. The method of claim 4, wherein the prediction instruction is obtained through the neural network model by:
performing prediction processing on the virtual task based on historical execution data of the first account for another virtual task, to obtain the prediction instruction for displaying the map,
the another virtual task being a virtual task in the virtual scene other than the virtual task, the neural network model being obtained through training by using historical execution data of a virtual task sample and an account sample of the virtual scene for another virtual task sample and a prediction instruction label, and the another virtual task sample being a virtual task in the virtual scene other than the virtual task sample.

6. The method of claim 1, wherein the displaying the map comprises:
displaying the map around the indicator, wherein a center of the map is one of the indicator, the current position, or the target position.

7. The method of claim 1, wherein the portion of the virtual scene within which the map is displayed does not overlap the indicator, and displaying the map in the virtual scene comprises:
displaying a copy of the indicator within the map, wherein a center of the map is one of the copy of the indicator, the current position, or the target position.

8. The method of claim 1, wherein after the displaying the map in the virtual scene, the method further comprises:
closing the displayed map in the virtual scene when a close condition for the map is satisfied.

9. The method of claim 8, wherein the close condition for the map comprises one or more of:
receiving a close operation performed by a first account on the map, the first account being an account that controls the virtual object;
a stay duration of the virtual object at the current position duration being less than or equal to a stay duration threshold;
while the virtual character is moving towards the target position, a decrease of the distance between the current position and the target position is greater than a decrease threshold;
reaching, by the virtual object, the target position; or
failing to complete, by the virtual object, the virtual task at the target position.

10. The method of claim 1, wherein after the displaying the map, the method further comprises:
controlling the virtual character to be teleported to the target position in response to a teleportation trigger operation on the map.

11. The method of claim 10, wherein the controlling the virtual character to be teleported comprises:
controlling, in response to a trigger operation performed on a target area in the map, the virtual character to be teleported to the target position in a target teleportation manner, the target area being one of the following: the target position, the indicator, or a copy of the indicator.

12. The method of claim 11, wherein before the controlling the virtual character to be teleported to the target position in a target teleportation manner, the method further comprises:
displaying at least one candidate teleportation manner in the virtual scene; and
determining, in response to a selection operation performed on the at least one candidate teleportation manner, a selected candidate teleportation manner as the target teleportation manner.

13. The method of claim 11, wherein before the controlling the virtual character to be teleported to the target position in a target teleportation manner, the method further comprises:
determining the target teleportation manner from a plurality of candidate teleportation manners.

14. The method of claim 13, wherein the determining the target teleportation manner from the plurality of candidate teleportation manners comprises:
determining a matching candidate teleportation manner in the plurality of candidate teleportation manners as the target teleportation manner, a type of the matching candidate teleportation manner comprising at least one of the following: a candidate teleportation manner matching the distance between the current position and the target position, a candidate teleportation manner matching a landform between the current position and the target position, a candidate teleportation manner matching the virtual task at the current position, or a candidate teleportation manner matching a virtual task at the target position.

15. The method of claim 13, wherein the determining the target teleportation manner from the plurality of candidate teleportation manners comprises:
invoking a neural network model based on the first account that controls the virtual character to perform prediction processing on the plurality of candidate teleportation manners, to obtain the target teleportation manner, the neural network model being obtained through training by using an account sample, a candidate teleportation manner sample, and a target teleportation manner label.

16. The method of claim 13, wherein the determining the target teleportation manner from the plurality of candidate teleportation manners comprises:
invoking a neural network model based on the first account that controls the virtual character, the distance between the current position and the target position, and a landform between the current position and the target position to perform prediction processing on the plurality of candidate teleportation manners, to obtain the target teleportation manner, the neural network model being obtained through training by using an account sample, a distance sample, a landform sample, a candidate teleportation manner sample, and a target teleportation manner label.

17. The method of claim 10, wherein before the controlling the virtual object to be teleported to the target position, the method further comprises:
displaying at least one of the following in the small map:
the landform between the current position and the target position;
the distance between the current position and the target position; or
the route between the current position and the target position.

18. One or more non-transitory computer readable media comprising computer readable instructions which, when executed by a processor, configure a data processing system to perform:
displaying a virtual scene, the virtual scene comprising a virtual character;
displaying an indicator of a virtual task in the virtual scene when a predetermined virtual task condition is met, the indicator being configured for pointing from a current position of the virtual character to a target position of the virtual task; and
displaying a map within a portion of the virtual scene when a predetermined map condition is satisfied, wherein the target position is displayed in the map.

19. The computer readable media of claim 18, wherein the predetermined map condition is based on a prediction instruction returned by a neural network model for displaying the map, wherein the prediction instruction is obtained through the neural network model by:
performing prediction processing on the virtual task based on historical execution data of the first account for another virtual task, to obtain the prediction instruction for displaying the map,
the another virtual task being a virtual task in the virtual scene other than the virtual task, the neural network model being obtained through training by using historical execution data of a virtual task sample and an account sample of the virtual scene for another virtual task sample and a prediction instruction label, and the another virtual task sample being a virtual task in the virtual scene other than the virtual task sample.

20. A system, comprising:
a processor; and
memory storing computer readable instructions which, when executed by the processor, configure the system to perform:
displaying a virtual scene, the virtual scene comprising a virtual character;
displaying an indicator of a virtual task in the virtual scene when a predetermined virtual task condition is met, the indicator being configured for pointing from a current position of the virtual character to a target position of the virtual task; and
displaying a map within a portion of the virtual scene when a predetermined map condition is satisfied, wherein the target position is displayed in the map.
